(19) United States
(12) Patent Application Publication
(10) Pub. No.: US 2008/0012776 A1
(43) Pub. Date: Jan. 17, 2008

(54) Method of mounting and dismounting an antenna on a vehicle roof

(75) Inventor: Gunther Blickle, Walddorfhaeslach (DE)

Correspondence Address: K.F. ROSS P.C., 5683 RIVERDALE AVENUE, SUITE 203 BOX 900, BRONX, NY, 10471-0900, US

(73) Assignee: HIRSCHMANN CAR COMMUNICATION GMBH

(21) Appl. No.: 11/584,348

(22) Filed: Oct. 20, 2006

(30) Foreign Application Priority Data
Oct. 22, 2005 (DE) 102005050748.4

(51) Int. Cl. H01Q 1/32

(52) U.S. Cl. 343/713

(57) ABSTRACT

The invention relates to a method of mounting and dismounting a roof antenna (1) on a vehicle roof (2) of a vehicle, the roof antenna (1) being provided with a base plate (3) with at least one antenna element (5 to 8) and with a cover hood (10) for covering the interior of the roof antenna (1) and the base plate (3) is connected with the vehicle roof (2) by a fastener where according to the invention in particular the base plate (3) is provided with a fastener with which, in a first step, the cover hood (10) is installed on the roof antenna (1) and, for removing the cover hood (10) in a further step, the fastener is designed such that the installation step differs from the removal step.

The invention relates to a method of mounting and dismounting a roof antenna on a roof of a vehicle as well as to a correspondingly designed roof antenna according to the features of the preamble of the independent claims.

A vehicle's roof antenna provided with a base plate is known from the German utility model DE 20 2004 004 740 U1. The base plate carries a circuit board on which antenna elements are mounted and is covered by an inner hood serving as a protection during transport and the installation. The inner hood is connected with the base plate by latch formations. In addition, this inner hood is enclosed by an outer hood that is fastened by means of a link connection and a latch with a corresponding fastener that is provided on the inner hood. The outer hood can be correspondingly designed and serves to protect the antenna elements mounted inside it and the inner hood in order to avoid mechanical influences on the roof antenna and to simultaneously avoid that humidity and the like can get to the antenna elements of the roof antenna. Thus installation of the roof antenna of the utility model 20 2004 004 740 U1 is as follows:

The base plate with the antenna elements mounted on it and the inner hood mounted on it is latched to the outer hood. Subsequently, the outer hood is attached to the car body and glued on the car body by means of the surrounding adhesive edge on its bottom face. For removal, the same operations are carried out in the inverse order. If for example an outer hood is to be exchanged or if parts inside the roof antenna have to be accessed, first of all, the glue connection with the car body must be unstuck and then the latch connection between the exterior and the inner hood must be undone, the outer hood must be tilted and removed and finally the latch connection between the inner hood and the base plate has to be undone to ensure that the antenna elements or other elements of the roof antenna become accessible.

This inverse order of steps for the removal of the concerned elements, however, poses problems since the surrounding lower edge of the outer hood is flush with the vehicle roof and the glue joint can only be unstuck laboriously by mechanical action or by solvents and thus the means for latching the exterior and the inner hood are not accessible. In case they have to be accessed, destruction of the outer hood is unavoidable. At the same time it can come to pass that the surface of the vehicle roof is damaged, resulting in high repair costs.

Therefore, the object of the invention is a method of mounting and dismounting a roof antenna, in particular its cover hood, and the provision of a corresponding roof antenna, the above-described disadvantages being avoided. In particular, the invention should provide a fast and simple installation of the cover hood and as well a fast and simple removal of the installed cover hood without destruction or even insignificant or reparable damage to the cover hood.

This object is solved by the features of the independent claims.

According to the invention, the fastener of the cover hood by means of which in a first step, the cover hood is installed on the roof antenna, independent from the fact whether the roof antenna had already been fastened on the vehicle roof, and whether the fastener for the subsequent removal are designed such that the installation step differs from the removal step. Therefore and in a particularly advantageous manner, the installation is a latching operation and the removal is a screwing operation, other installation operations, in which the installation step differs from the removal step, being possible.

The method according to the invention will be described in the following using the example of the latching operation for the installation and the screwing operation for the removal. Once the roof antenna with its base plate and the antenna elements mounted on it (which may be mounted on a circuit board) are fastened in optional manners on the vehicle roof, the cover hood is put over the base plate and thus fastened on the vehicle roof by means of the latching operation. For this purpose, a fastener is provided that allow for the cover hood to be secured to the vehicle roof by means of the latching operation. This fastener can be part of the base plate and/or of the vehicle roof and is designed as a separately mountable fastener. This fastener is designed such that the cover hood can be installed efficiently and permanently on the vehicle roof, it being particularly advantageous if by the means of the installation of the cover hood on the vehicle roof a seal becomes efficient between the base plate and the cover hood. Thus, simultaneously with the installation of the cover hood, sealing against external influences on the whole sensible interior of the roof antenna is realized in a fast, easy and efficient manner.

In a further embodiment of the invention, the roof antenna, in addition to the cover hood, is provided with an intermediate hood, the intermediate hood being enclosed by the cover hood and the roof antenna, with the intermediate hood mounted and fastened on the base plate, is first of all mounted and fastened on the vehicle roof and subsequently, the installation of the cover hood is carried out. Thus, as known from the state of the art, the interior of the roof antenna can be protected against external influences during transport and installation by means of the intermediate hood, subsequently and according to the invention the installation and, in case of repair, the removal of the cover hood can be carried out.

Due to the method according to the invention and the corresponding design of the relevant parts of the roof antenna, on the one hand, a fast and easy installation of the roof antenna is possible since the base plate can be fastened in a known manner on the vehicle roof and subsequently, the installation of the cover hood is carried out in a first installation step. The fastener designed for that purpose secures the cover hood efficiently and permanently on the vehicle roof such that the installation of the roof antenna on the vehicle roof is completed. Furthermore, according to the invention, in case a repair is necessary, the fastener with which the cover hood has been fastened can be unfastened in another operation for removing the cover hood without damage. For this purpose, the fastener is, in a particularly advantageous manner, accessible from the bottom of the vehicle roof such that e.g. a screwing operation can be carried out for unfastening and removing the cover hood. In case this fastener is not accessible, in particular if it are not accessible from the bottom of the vehicle roof, the cover hood can be opened in a further embodiment of the invention at the fastener in order to apply a tool for the removal of the roof antenna. Such an opening procedure can e.g. consist in a drilling operation that exposes the fastener in order to fit the tool to it. This way, it is particularly advantageous if the opening is at a position that is well spaced from the surface of the vehicle roof. Furthermore, a central fastener is particularly advantageous since this way the cover hood has to be provided with only one opening at a position that is well spaced from the surface of the vehicle roof in order to avoid damages of the vehicle roof during the removal.

Furthermore, a roof antenna is claimed that is designed such that the cover hood can be installed and maybe removed according to one of the previous claims. Corresponding embodiments of such roof antennas are described in the following and are explained by the means of figures, the embodiments illustrated in the figures being particularly advantageous embodiments that could also be designed differently such that, in a first installation step, the cover hood can be installed and, in a further step, removed, the installation step differing from the removal step.

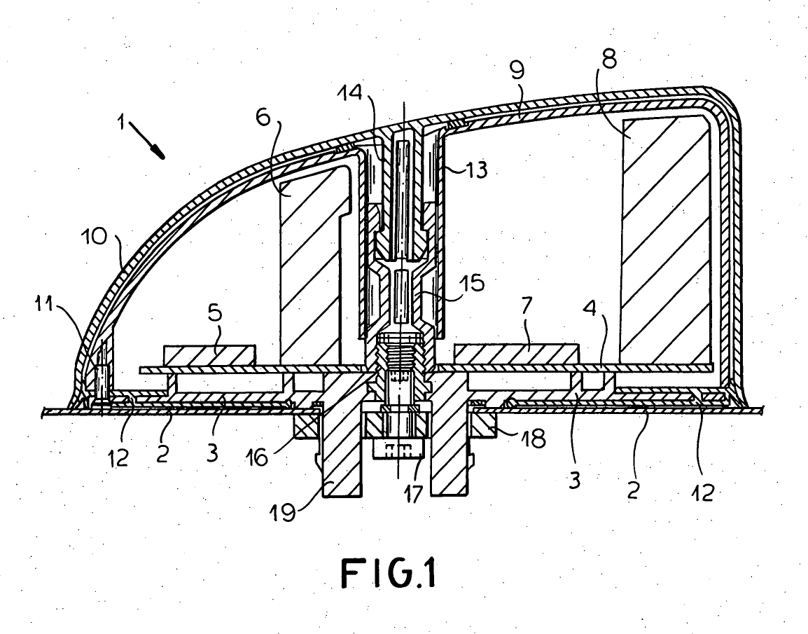

FIGS. 1 to 5, as far as illustrated in detail, show the constructive design of a roof antenna 1 for installation on a vehicle roof 2. The basic, but only exemplary, assembly of the roof antenna 1 is provided with a base plate 3 on which a circuit board 4 is mounted and fastened, the circuit board 4 being provided with at least one antenna element, in particular with several antenna elements 5 to 8 for different frequency ranges. These antenna elements, the circuit board and the base plate can be covered by an intermediate hood 9, but they do not have to. When there is no intermediate hood 9, a cover hood 10 covers the interior of the roof antenna 1. In case there is an intermediate hood 9, the cover hood 10 is fitted over the intermediate hood 9 and encloses it. The intermediate hood 9 is connected with the base plate 3, for example by means of a screw connection 11, which also can be at any of several positions. Between the bottom face of the base plate 3 and the surface of the vehicle roof 2, a seal 12 is arranged, in particular a planar seal. In the embodiment according to FIG. 1, the intermediate hood 9 is provided with a sleeve 13 mounted at a central position and usually vertical, in which sleeve a latch pin 14 of the cover hood 10 as well as a connector part 15 are fitted. In addition, the connector part 15 is provided with a threaded part 16 and a screw 17. The threaded part 16, however, can also be formed on the base plate 3. The elements 14 to 17 are the fastener for the cover hood 10 that in this embodiment is supported on the vehicle roof 2. Alternatively or complementarily, the cover hood 10 can also be supported on the base plate 3 or (if provided) on the intermediate hood 9 of the already installed roof antenna 1.

This fastener, its function and the installation process will be explained below. Furthermore, a clamping plate 18 is provided that is guided by means of a collar 19 of the base plate 3 pointing downward and which can be anchored by fastening the screw 17 or by a different fastening device.

The installation of the roof antenna 1 that is shown in FIG. 1 is carried out as follows:

Once the circuit board 4 and the antenna elements 5 to 8 have been mounted on the base plate 3 and in some cases once the intermediate hood 9 has been installed, the collar 19 of the base plate 3 is fitted through a hole in the vehicle roof and the clamping plate 18 is attached to the vehicle roof 2 by means of the screw 17 that is inserted into the threaded part 16. The threaded part 16 either is part of the base plate 3 or a separate element that can be installed on the base plate such that the clamping plate 18 can be moved toward the bottom face of the vehicle roof 2 and fastened there by screwing the screw 17 into the threaded part 16. By means of this clamping connection, the base plate 3 bears on the vehicle roof 2 after installation of the seal 9. The procedure described hitherto, however, does not concern the installation and a possible following removal of the cover hood 10, because this procedure is explained further below.

The complementarily shaped cover hood 10 oriented with its latch pins 14 pointing downward is moved through the sleeve 13 of the intermediate hood 9 toward the connector part 15. The upper area of the connector part 15, i.e. its interior, corresponds to the end area of the latch pin 14, in particular to its outside contour. If the cover hood 10 is moved toward the vehicle roof 2, the confronting end regions of the latch pin 14 and of the connector part 15 are brought into connection because they are dimensioned such that they lock into each other if the lower surrounding edge of the cover hood 10 bears on the vehicle roof 2. If necessary, this contact can be carried out by placing and/or introducing a further seal that is not illustrated. In the illustrated embodiment according to FIG. 1, the lower surrounding edge of the cover hood 10 is thinner than the rest of the edge of the cover hood 10 in profile such that a slight but desired deformation can occur. Furthermore, the inner region of the lower surrounding edge of the cover hood 10 bears on the seal 12 and deforms it insignificantly such that sealing is carried out permanently and reliably. For this installation procedure of the cover hood 10 the concerned elements 14, 15, 16 are coordinated such that the latch between the latch pin 14 and the connector part 15 is effected when the cover hood 10 has reached its desired position on the vehicle roof 2. This latching operation is the first installation step for fitting and fastening the cover hood 10 to the vehicle roof 2. Since in this position the latch cannot be unfastened, the fastener of the cover hood 10 (reference numbers 14 to 17) is designed such that it can be actuated in a different installation step (here a screwing operation) for unfastening the cover hood 10, i.e. for removing it. In a first illustrated embodiment of this fastener, the connector part 15 and the threaded part 16 are either made in one piece or made as separate pieces that be connected with each other such that the upper end area of the connector part 15 is mounted in a position in which it can receive the connection area of the latch pin 14. In order to achieve a simpler interfit when the latch pin 14 and the connector part 15 are brought together, they can be provided with beveled inlets. Moreover, the latch pin 14 is hollow such that installation forces can be maintained low during the latching operation. Besides, attention could be paid to the fact that the height of the connector part 15 is adjustable in the sleeve 13, since a thread connection between the lower area of the connector part 15 and the threaded part 16 and/or the upper area of the connector part 15 and the sleeve 13 is provided. It is understood that the cover hood 10 can also be installed, if no intermediate hood 9 is provided or if an intermediate hood 9 is provided, but without the sleeve 13. The sleeve 13, however, is particularly advantageous for supporting the connector part 15.

In order to interfere as little as possible with the sending and receiving characteristics of the antenna elements 5 to 8, the adjacent elements, in particular the hoods 9, 10 as well as the fastener 14 to 17, can be produced of an electrically nonconductive material, such as plastic. Furthermore, the threaded part 16 and the screw 17, however, can be produced of an electrically conductive material, since they are basically mounted in an area that does not interfere with the function of the antenna elements 5 to 8.

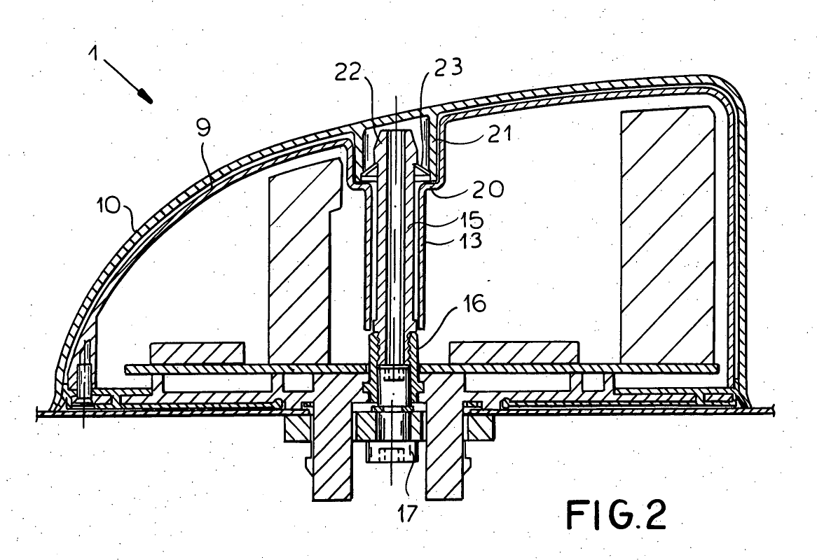

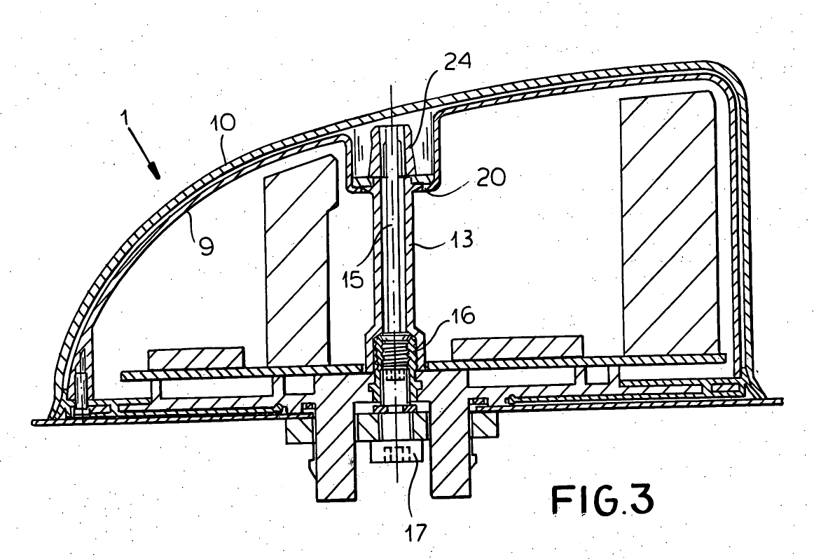

FIGS. 2 and 3 show alternative embodiments of the fastener for the installation and removal of the cover hood 10. As shown in FIG. 2, the sleeve 13 of the intermediate hood 9 is provided with an offset 20, the cover hood 10 further being provided with a downwardly directed collar 21 of the same shape as the offset 20. The connector part 15 in turn is provided with an offset at its end that corresponds to a latch spring 23 that can be mounted on the offset 20. Thus, once the connector part 15 has been fastened to the threaded part 16, the connector part 15 projects upward and the cover hood 10 is put over the end 22 of the connector part 15 in the area of the holder 21 provided with an opening. Thus, after reaching the desired position of the cover hood 10 on the vehicle roof 2, the latch spring 23 mounted on the offset of the end area 22 of the connector part 15 becomes effective such that the cover hood 10 is locked in place after the interlocking. Subsequently, the cover hood 10 can only be removed after unscrewing the screw 17 by inserting a tool from below into the connector part 15, thanks to which the connector part is unscrewed from the threaded part 16. Thus, also in this illustrated embodiment, the cover hood 10 can be installed by a latching operation and removed by a screwing operation. The same is true for the illustrated embodiment according to FIG. 3, the connector part 15 also being fastened on the threaded part 16 and pointing up. In this illustrated embodiment, too, the intermediate hood 9 is provided with the basket-shaped offset 20, the cover hood 10 being provided with a fastening formation 24 provided with an opening that is fitted over the end area 22 of the connector part 15 such that they are interlocked.

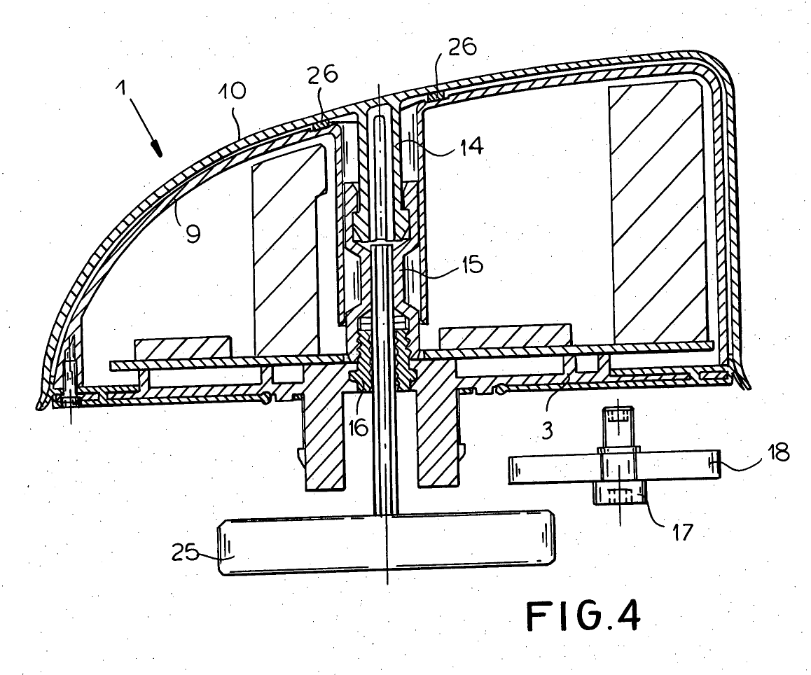

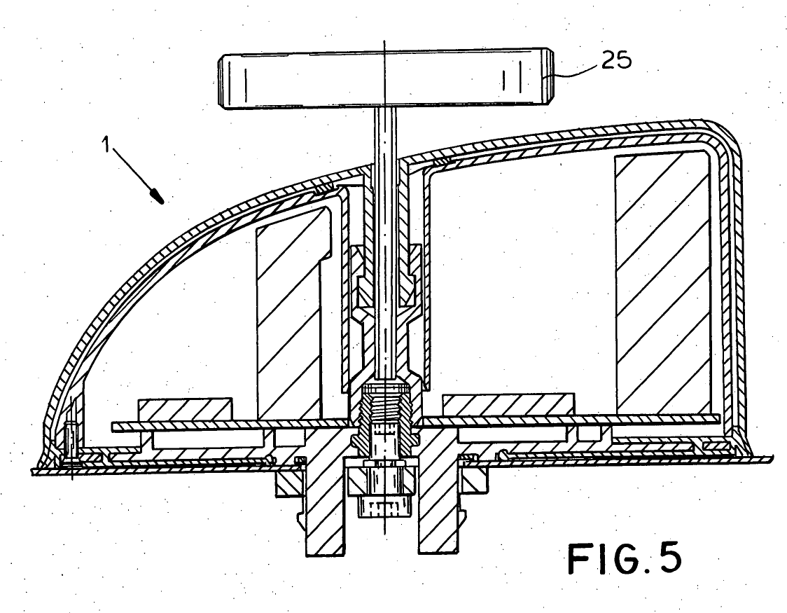

FIGS. 4 and 5 show two alternative removal operations of the cover hood 10 with a tool 25. As shown in FIG. 4, in a first step, the screw 17 and its clamping plate 18 were unfastened such that the fastener of the cover hood 10 is accessible from below, without the cover hood 10 having to be destroyed or partially damaged. In this case, the threaded part 16 is firmly mounted in the base plate 3 (or is a part of the base plate 3) and the downwardly pointing end area of the connector part 15 is screwed on the upper region of the threaded part 16. The connector part 15 with the interlocked latch pin 14 of the cover hood 10 can now be moved by means of the tool 25, since a rotary movement is possible both between the latch pin 14 and the connector part 15 and between the connector part 15 and the threaded part 16. By applying the tool 25, the connector part 15 is turned and due to a thread connection between the connector part 15 and the threaded part 16, it can be axially moved upward and unfastened from the base plate 3. Thus, it is also possible to unfasten the cover hood 10 by the described screwing operation. Alternatively, FIG. 5 shows that the cover hood 10 is partially opened, e.g. by a drilling operation. Through this opening, which can be closed after the removal, the tool 25 can be applied in order to fasten the connector part 15 in an analogical way as described in FIG. 4. Thus, in this operation, the connector part 15 is axially moved upward by means of the threaded part 16. Once the cover hood 10 has been removed, the connector part 15, which is for example made of plastic, is removed from the latch pin 14 and for the purpose of the subsequent reinstallation of the cover hood 10, it is screwed back on the threaded part 16, such that the installation of the cover hood 10 can be carried out as described above. If required, new pieces of the cover hood 10 and of the connector part 15 can be used for the reinstallation or the old pieces can be reinstalled, the drilled hole in the cover hood 10 having been closed previously.

### REFERENCE NUMBERS

1 Roof Antenna
2 Vehicle Roof
3 Base Plate
4 Circuit board
5 Antenna Element
6 Antenna Element
7 Antenna Element
8 Antenna Element
9 Intermediate Hood
10 Cover Hood (also called Design Hood)
11 Screw Connection
12 Seal
13 Sleeve
14 Latch pin
15 Connector part (also called latching sleeve)
16 Threaded part
17 Screw
18 Clamping Plate
19 Collar
20 Offset
21 Holder
22 End region
23 Latch Spring
24 Fastening Device
25 Tool
26 Shoulder

1. A method of mounting and dismounting a roof antenna on a vehicle roof of a vehicle, the roof antenna being provided with a base plate with at least one antenna element and a cover hood for covering the interior of the roof antenna and the base plate is connected with the vehicle roof by fastenings means, characterized in that in particular the base plate is provided with a fastener by means of which, in a first step, the cover hood is installed on the roof antenna and in that, for removing the cover hood in a further step, the fastener is designed such that the installation step differs from the removal step.

2. The method according to claim 1 characterized in that the installation step is a latching operation and the removal step is a screwing operation.

3. The method according to claim 1 characterized in that a seal between the base plate and the cover hood becomes effective when the cover hood is installed on the vehicle roof.

4. The method according to claim 1, characterized in that the roof antenna, in addition to the cover hood, is provided with an intermediate hood, the intermediate hood being enclosed by the cover hood and at first the roof antenna and the intermediate hood that is mounted and fastened on the base plate are mounted and fastened on the vehicle roof a and subsequently the installation of the cover hood is carried out.

5. The method according to claim 1, characterized in that the cover hood is opened at the position where the fastener is provided for the purpose of applying a tool for the removal of the roof antenna.

6. A roof antenna that is designed such that the cover hood can be installed and, if necessary, removed according to claim 1.

8. The roof antenna according claim 1, characterized in that the fastener is formed as a sleeve, that at its lower end is provided with a thread for being screwed into the base plate and with an interlocking geometry at the upper end for interlocking with the cover hood and, on its inside, with an application point for a rotation tool.

9. The roof antenna according to claim 1, characterized in that the cover hood is provided with a cone-shaped offset with an interlocking geometry that interacts with the interlocking geometry of the fastener and that can be engaged with the interlocking geometry.
